(19) United States
(12) Patent Application Publication
(10) Pub. No.: US 2023/0400003 A1
(43) Pub. Date: Dec. 14, 2023

(54) AN IMPROVED SYSTEM AND METHOD FOR GENERATING ELECTRICAL ENERGY FROM AIR HYDROPOWER

(71) Applicant: SANDIP PRALHAD GADE, NASHIK (IN)

(72) Inventor: SANDIP PRALHAD GADE, NASHIK (IN)

(21) Appl. No.: 18/252,036

(22) PCT Filed: Mar. 18, 2021
(86) PCT No.: PCT/IB2021/052268

§ 371 Date: May 7, 2023

(30) Foreign Application Priority Data
Jan. 21, 2021 (IN) 202121002851

(51) Int. Cl. F03B 1/00

(52) U.S. Cl. CPC F03B 1/00; F05B 2210/18; F05B 2220/706

(57) ABSTRACT

The present invention provides an improved system for generating electrical energy from air hydropower. The system includes a series arrangement of more than one vessel where each of the vessel is cylindrical in shape at center, a dome shaped structure at top and a narrow conical structure at bottom, a mechanical drive machine and a fulcrum assembly having an effort arm and a resistance arm resting on a static support, an injection pumping system which includes an injection pump which is separated into two compartment by the piston plate, a Y shaped penstock connected at the narrow conical structure at one end and formed from more than one narrow piping merging into a single pipe and a pen stock jet placed over the penstock, here the jet is injected with air bubbles which pushes the water from the penstock at high velocity over a Pelton wheel of a Pelton turbine which in turn moves a turbine shaft to generate electricity.

### TECHNICAL FIELD

This application generally relates to an improvement of Indian patent application number 201721045318. The present invention relates to an improved system for generating electricity from air hydropower. More particularly, the present invention provides an integration of air hydropower, whereby the system uses a fulcrum arrangement and also removes gravity plates or piston plates with rubber within the vessel to make more robust and efficient design and thereby improving the overall efficiency of the system for generating power.

### BACKGROUND

We generate a major part of power through traditional methods like thermal, nuclear and hydro energy and through non-traditional methods like solar, wind and tidal energy. However, majority of the current Power plants uses exhaustible resources like coal, diesel, gas, nuclear resources etc. to generate Power. Some others use the natural resources of Solar, Wind and Hydro energy to generate Power. However, these natural resources require a huge area, high cost of production, heavy infrastructure cost and too many resources, while providing a very small output.

Generally, dams are specifically made for hydroelectricity generation. A hydro electricity generator used for the generation of hydroelectricity may produce air pollutants, thereby affecting environment. There are many environmental consequences that occurred from the use of hydroelectric generator. The dam and a reservoir may obstruct fish migration in a way that the fish habitats are shaped by physical factors such as water level, water velocity and shelter opportunities and access to food. Draining would be completely destructive to the fish. Beyond this, the amount of water may have different effects on the fish in a river, depending on the type and stage of the lifecycle. The dam and the reservoir can also change natural water temperatures, water chemistry, river flow characteristics, and silt loads. These changes may have negative impacts on animals in and around the river. Also, the crisis of water in the river and dams lead to generate less hydroelectricity.

Hydroelectric dams have a geographical limitations and cannot be set up any location. Further, greenhouse gases like carbon dioxide and methane may also form in the reservoirs which can be emitted to the atmosphere. The exact amount of greenhouse gases produced in hydroelectric reservoirs is uncertain. Moreover, the hydroelectric power plants are expensive to construct and require very large area for power plant. This also has a geographical limitations and reallocation of the habitants are also higher in hydroelectric plants displacement for low generation of power. There is no such hydroelectric power system as on date which is able to succeed in dealing with these ongoing problems.

The above mentioned traditional methods of power generation use exhaustible sources of energy which have an expiry date and which cause a lot of pollution in the air and environment. They also incur huge costs of production, use different raw materials and the maintenance cost is also very high. The non-traditional methods mentioned above use up a lot of space and cannot run at a consistent pace in a given 24 hour day. They incur a heavy cost of construction and the output is relatively small.

Therefore, to overcome the above hurdles in power generation, a system of generating electricity from air hydropower was proposed in our previous application 201721045318 However, there is a need to provide an improved system which will efficiently maintain pumping of water into the Vessel from the reservoir. Also simplified pressure maintenance in the vessel is desired which can overcome the limitation and drawbacks of existing system.

### OBJECTS OF THE INVENTION

An object of the present invention is to provide a system for generating electricity from air hydropower.

Another object of the present invention is to provide a system for generating electricity from air hydropower, which causes no air pollution, thereby protecting environment and is a green source of energy.

Yet another object of the present invention is to provide a system for generating electricity from air hydropower, which requires very less space for the production of large amount of power.

Further object of the present invention is to provide a system for generating electricity from air hydropower, which can produce constant power in all seasons and all environmental conditions.

Further one of the object of the present invention is to provide a system for generating electricity from air hydropower having recycling process, whereby same volume of water generates power multiple times.

One more object of the present invention is to provide a system for generating electricity from air hydropower, which has high efficiency.

Further object of the present invention is to provide a system for generating electricity from air hydropower, which no geographical and topographical limitations or challenge in installation.

Further one object of the present invention is to provide a system for generating electricity from air hydropower having less construction and maintenance cost by using very small area

Another object of the present invention is to provide a system for generating electricity from air hydropower, which is simple and economical in operation.

Yet another object of the present invention is to provide a system for generating electricity from air hydropower, which is robust in operation.

Further object of the present invention is to a system for generating electricity from air hydropower, which may possibly upgrade to convert thermal power plant to air hydro power plant.

### SUMMARY OF THE INVENTION

According to the present embodiment, there is provided a system for generating electricity from air hydro power. The system includes a series arrangement of more than one vessel characterized in that wherein each of the vessel is cylindrical in shape at center, a dome shaped structure at top and a narrow conical structure at bottom, such that the vessels connected to an injection pumping system at the bottom side and to an air surge tank at top of the vessel such that the pressure in all the vessels are maintained in the range 5 Bar to 300 Bar, a mechanical drive machine and a fulcrum assembly having an effort arm and a resistance arm resting on a static support, wherein the effort arm is connected to a drive mechanism and the resistance arm is connected to a piston rod, wherein the piston rod is connected to a piston plate with a rubber seal for pumping water from a reservoir, an injection pumping system which includes an injection pump which is separated into two compartment by the piston plate, wherein each of the compartment has an input valves and an output valves that pumps water from the reservoir into the vessels, a Y′ shaped penstock connected at the narrow conical structure at one end and formed from more than one narrow piping merging into a single pipe, wherein the penstock receives pressurized water from the vessel continuously at same volume and pressure as received from the injection pumping system to the vessel, and a pen stock jet placed over the penstock, wherein the jet is injected with air bubbles through an air bubble injection system and pushes the water from the penstock at high velocity over a Pelton wheel of a Pelton turbine which in turn moves turbine shaft, wherein the shaft is connected to a generator to generate electricity.

In an embodiment, the drive machine when moves upwards and downwards with movement of effort arm and resistance arm, the resistance arm connected to the pump piston moves in upward direction towards point (a) the inlet valve of Compartment B opens and outlet valve of compartment B closes and at the same time compartment A outlet valve opens and inlet valve of compartment A closes, wherein when pump piston moves in downward direction towards point (b) the inlet valve of compartment A opens and outlet valve of compartment A closes, at the same time outlet valve of compartment B opens and inlet valve of compartment B closes.

In one embodiment, the air surge tank uses a high pressure air compressor to generate lower volume at high pressure air to fill air in the air surge tank at required bar and volume. The pressurized water from at least one vessel or from series of vessels may be released over the turbine by a penstock.

In an embodiment, the airdrop injection facilitates the penstock jet to boost impact torque over the turbine blade to produce more rpm. A gear assembly may be used between the turbine and the generator for increasing the rpm.

In an embodiment, the generator is connected to a step-up transformer is used for transferring the electricity to a grid.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments:

The embodiments herein will be better understood from the following detailed description with reference to the drawings, in which:

FIG. 1 illustrates a block diagram of an improved system for generating electricity from air hydro power according to an embodiment mentioned herein;

FIG. 2A illustrates fulcrum drive mechanism which is used in the air hydro power generation system according to an embodiment mentioned herein;

FIG. 2 B illustrates a drive machine mechanism that is used in the air hydro power generation system according to an embodiment mentioned herein.

FIG. 3 illustrates an injection pumping system that is used in the air hydro power generation system according to an embodiment mentioned herein;

FIG. 4 illustrates a multiple vessels arranged such that to generate jet stream of water to drive Pelton turbine according to an embodiment mentioned herein;

FIG. 5 illustrates a penstock jet realizing jet stream over a Pelton wheel of thePelton turbine according to an embodiment mentioned herein; and

FIG. 6 illustrates a schematic view of entering jet stream of water into the wheel and exiting jet stream of water from the wheel of thePelton turbine according to an embodiment mentioned herein.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE INVENTION

An embodiment of this invention, illustrating its features, will now be described in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

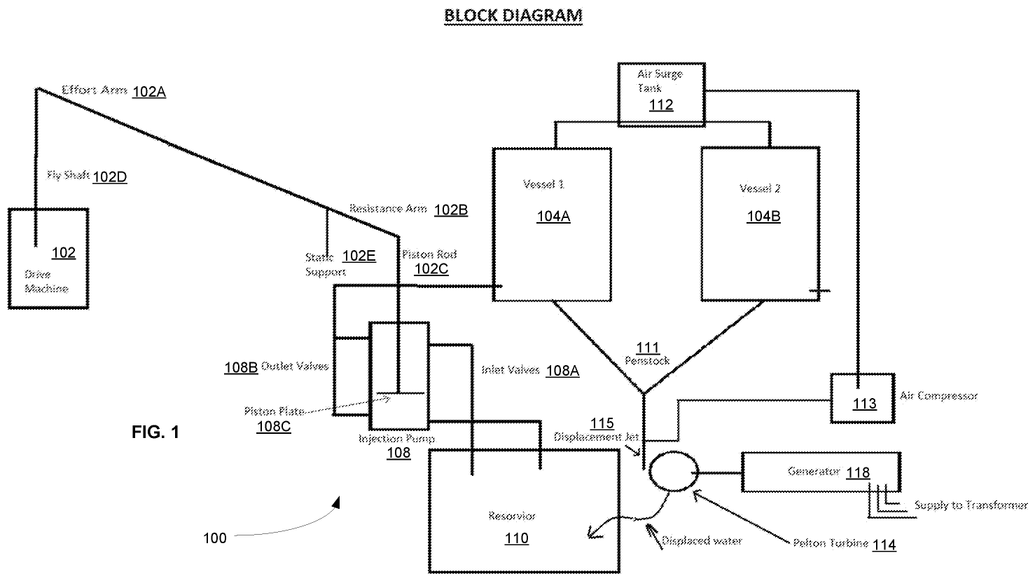

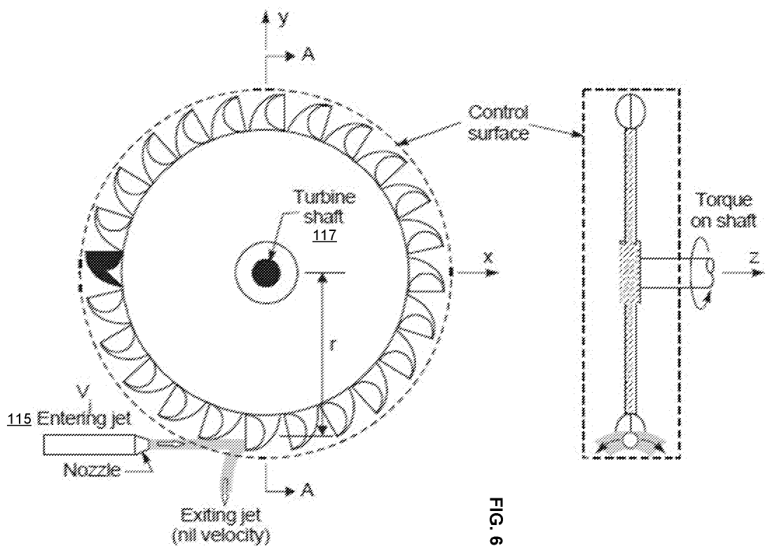

Accordingly, there remains a need to provide an improved system which will efficiently maintain pumping of water into the vessel from reservoir. Also simplified pressure stabilization in the vessel is desired which can overcome the limitation and drawbacks of existing system. The present improved system herein provides an integration of air hydropower, whereby the system uses a fulcrum arrangement and also removes gravity plates or piston plates with rubber within the vessel to make more robust and efficient design and thereby improving the overall efficiency of the system for generating power. The system also proposes other improvements which shall be discussed herein after. Referring now to the figures, more particularly to FIG. 1 and FIG. 6, where similar reference characters denote corresponding features consistently throughout the figures, preferred embodiments are shown.

A system 100 for generating electricity from air hydropower is provided herein. The system causes no air pollution, thereby protecting environment and provides green source of energy. Also, the system requires very less space for the production of large amount of electricity. The system may produce constant electricity in all seasons and environmental conditions at any location on the Earth. The system is having less construction and maintenance cost by using very small area. Further, the system is having high efficiency. Also, the system may be able upgrade to convert thermal power plant into an air hydro power plant. Furthermore, the system is simple and economical in operation. Moreover, the system is robust in operation.

FIG. 1 illustrates a block diagram of an improved system 100 for generating electricity from air hydro power according to an embodiment mentioned herein. The system includes a series arrangement of more than one vessel 104A-104B, a fulcrum assembly 200, a drive machine 102, an injection pumping system 300, a Y′ shaped penstock 111, a Pelton turbine 114 and generator 118.

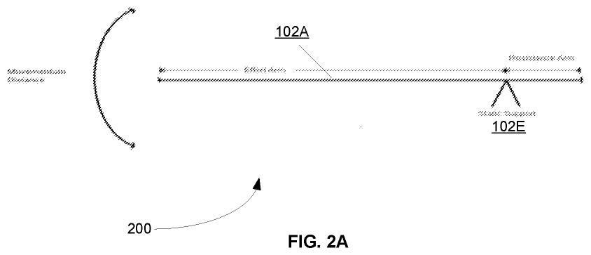

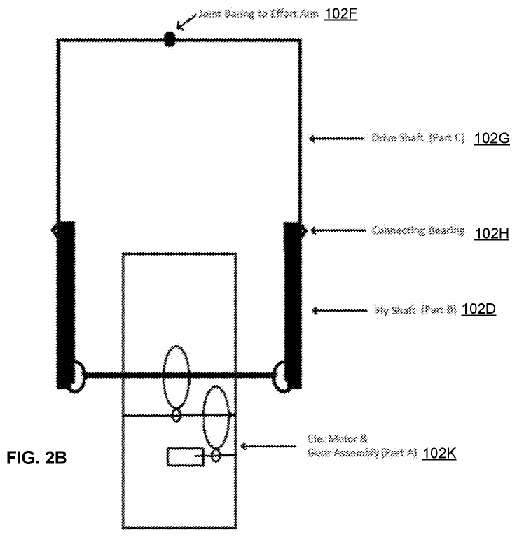

FIG. 2 (A) illustrates a fulcrum mechanism 120 which is used in the air hydro power generation system according to an embodiment mentioned herein. The fulcrum drive a fulcrum assembly 200 having an long rod divided into two parts is effort arm 102A and a resistance arm 102B resting on a static support 102E, wherein the effort arm is connected to a drive mechanism 102 and the resistance arm is connected to a piston rod 102C is connected to a piston plate 108C with a rubber seal 108D for pumping water from a reservoir 110, wherein the piston rod is connected to a piston plate for pumping water from the reservoir.

FIG. 2 (B) illustrates a drive machine 102 mechanism that is used in the air hydro power generation system according to an embodiment mentioned herein. In this system, we use mechanically driven machine-like oil extraction machine for extraction of crude oil from rigs. By this we mean that the machine will work as pistons converting higher RPM of electric motor to lower RPM with mechanical conversion of energy. This machine will have electrical motor with gear system and big size fly shaft attached with drive shaft on both sides.

The drive shaft moves up and down with the rotation of fly shaft and hence acts like a piston. The drive shaft is connected with effort arm by joint bearing. In this system the electrical energy is converted into mechanical energy. Which may be used to produce force to move the effort arm up and down.
PART A—The electric motor connected with the gear assembly which is connected to the main gear shaft to drive the fly shaft.
Part B—Two fly shafts are attached to the main gear shaft and the fly shaft are further attached to drive shaft externally from both sides, there by the drive shaft will move up and down like a piston on the rotation of the wheels.
Part C—The drive shaft is connected to the effort arm with a joint bearing. Fly shaft diameter will depend on the movement of distance of effort arm.

When the drive shaft moves upward direction the connected effort arm also moves upwards, same is the case when the drive shaft moves in downwards direction the effort arm also moves down. One side of the effort arm is connected to the drive machine (Drive shaft) and the other end of the effort arm is connected to the injection pumping system. There is a static support given to the effort arm closer to the injection pump joint bearing.

The effort arm is divided into two parts and as the effort arm moves upwards the second part which is the resistance arm moves downward direction and as the effort arm moves in downwards direction the resistance arm moves in the upward direction. This is regularly repeated cycle. It works like a fulcrum to operate the injection pump for pulling and pushing the pump piston.

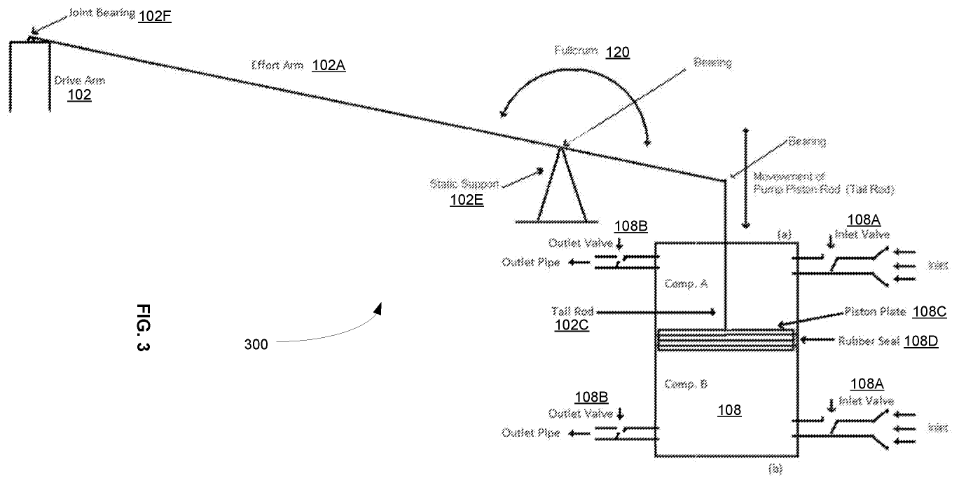

FIG. 3. illustrates the injection pumping system 300 which includes an injection pump which is separated into two compartment by a piston plate 108C, wherein each of the compartment has an input and output valves that pumps water from the reservoir into the vessels.

As shown in the FIG. 3 the injection pump has inlet valves 108A and outlet valves 108B on both sides. The pump is internally separated by piston plate 108C with a rubber seal, which work as an injection when force acts upon the piston plate. The pumps are separated into two compartment. A—which is Above the piston plate and compartment B—which is below the piston plate.

Each compartment also has separate inlet and outlet valves. When with the help of resistance arm pump piston moves in the upward direction towards point (a) the inlet valve of Compartment B opens and outlet valve of compartment B closes and at the same time compartment A outlet valve opens and inlet valve of compartment A closes. When pump piston moves in downward direction towards point (b) the inlet valve of compartment A opens and outlet valve of compartment A closes. At the same time outlet valve of compartment B opens and inlet valve of compartment B closes. This is continuous process and is running Vice-Versa between compartment A and Compartment B.

Both compartment inlet valve are connected to the reservoir and the outlet valves are connected to the high pressure vessel. As the inlet valve opens it takes the water inside the pump by gravity or by suction, when compartment A inlet valve opens it takes water inside compartment A and a same time compartment B outlet valve opens and water is pressurized in compartment B there by pumping water into the vessel.

When the piston moves upwards from point (b) to (a) The inlet valve of compartment B opens and water comes inside of the pump of compartment B. at that time the outlet valve of compartment B is closed and outlet valve of compartment A is open and inlet valve of compartment A is closed. In this process the water is pressurized in compartment A through outlet valve there by pumping the water into the vessel. This is the continuous process vice a versa. And the water is pumped up continuously into the vessel.

The speed of pumping and water flow depends on the drive speed of the drive machine. At the time of motion change of the piston plate there is a special movement stabilization which is fitted in the pump, so that it control the system stabilization at higher pressure at the pumping point of the outlet valve. The outlet valve are continuously working on higher pressure and the inlet valve during suction work on normal pressure and during pumping the work on higher pressure.

This type of pumping system fitted in line with different sizes and capacity help solve purpose of pumping continuously on very high pressure and with huge volume of water with very less input energy giving to drive machine. The above type of methodology of pumping will reduce input energy to pump up water at such a high pressure and volume by a very high percentage (Approx. 97%).

In this system very less energy is used to pump up the high pressure and high volume of water in the vessel with the help of Fulcrum (Law of Archimedes). The Fulcrum support works for you like a lever to pump up the water using less force.

Also according to Pascal's Law, the injection pumping system works more efficiently because of the difference in diameter in the injection pumping container and that of the vessels. As compared to the vessel the pumping container has a lower diameter and therefore the pumping happens at a lower force, in the high pressure vessel.

Pascal's Law states that, “When there is an increase in pressure at any point in a confined fluid, there is an equal increase at every other point in the container.”

Pascal's Law allows forces to be multiplied. The cylinder on the left shows a cross section area of 1 square inch, while the cylinder on the right shows a cross section area of 10 square inches. The cylinder on the left has a weight (force) of one pound acting downwards on the piston which lowers the fluid by 10 inches. As a result of this force, the piston on the right lifts a 10 pound weight at a distance of 1 inch.

The 1 pound load on the 1 square inch area causes an increase in pressure on the fluid in the system. This pressure is distributed equally throughout and acts on every square inch of the 10 square inch area of the large piston. As a result, the larger piston lifts up a 10 pound weight. The larger the cross section area of the second piston, the larger the mechanical advantage, and the more weight it lifts.
P1=P2 (since the pressures are equal throughout)
Since pressure equals force per unit area, then it follows that

F1/A1=F2/A2
It can be shown by substitution that the value as shown above are correct.
1 kg/1 square inches=10 kgs/10 squares inches
Because the volume of fluid pushed down on the left side equals the volume of fluid that is lifted up on the right side, the following formula is also true:

V1=V2
by substitution

A1 D1=A2 D2 (A=cross section area, D=the distance moved)

or A1/A2=D2/D1

The present embodiment of water pumping works on the above principle.

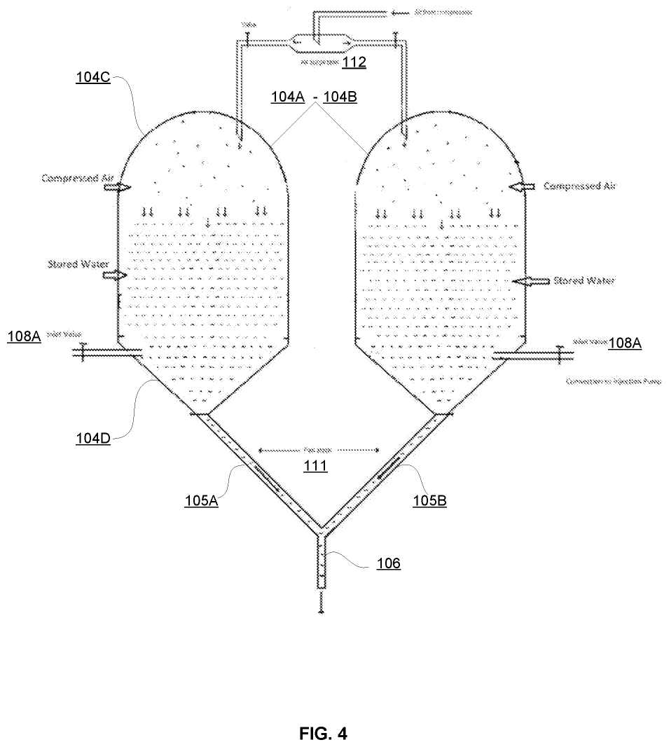

FIG. 4 illustrates a multiple vessels 104A-104B arranged such that to generate jet stream of water to drive Pelton turbine according to an embodiment mentioned herein. The vessels are a series arrangement of more than one vessel characterized in that wherein each of the vessel is cylindrical in shape at center, a dome shaped structure 104C at top and a narrow conical structure 104D at bottom, such that the vessel is connected to the injection pumping system 300 at the bottom side and to an air surge tank 112 at top of the vessel such that the pressure in all the vessels is maintained in the range 5 Bar to 300 Bar.

Here, a Y′ shaped penstock 111 is provided which is connected at the narrow conical structure 104D at one end and formed from more than one narrow piping 105A-105B merging into a single pipe 106. In an embodiment, the penstock receives pressurized water from the vessel continuously at same volume and pressure as received from the injection pumping system to the vessel.

There are 2 processes by which we can show the working and methodology of the Vessels. Both processes may be used as per convenience of output.

Process 1

Here we require two numbers of high-pressure vessel which will be connected at the bottom side to the injection pumping system and to the air Surge tank from the top of the vessel.

The two vessels will be connected to each other vertically and the bottom with outlet valves and ‘Y’ shaped penstock.

The water will be filled in this vessel by the injection pumping system up to 60% of their capacity which will be maintain at all time during the operation. Balance vessel will be filled with air.

Once the water is filled up to 60%, air will be filled in up to getting the desired pressure. As there is high pressure in the vessel the water will be displaced through the penstock and the same volume of the water will be pumped inside the vessel through the injection pump.

Once the pumped-up water comes into the vessel up to 60% then we will increase the air pressure in the vessel up to the desired Bar by filling more air in the vessel, once we get the desired pressure of the air through the air surge tank it goes into idle mode.

Then we open the outlet valve and release the high-pressure water in the Y shape penstock for further process. This is a continuous process and the volume of water displaced in the penstock is parallelly filled into the vessel through the injection pumping system. When air pressure is created it pushes the water surface downwards.

In case if the displaced water is more than the input water, the air will expand and the required air will again be filled by air surge tank automatically to maintain the desired pressure. When the input of water is more than the displacement then the air is compressed and release by air surge tank maintaining the same pressure.

Air surge tank takes air from the compressor and stores it at required pressure and volume to supply and discharge from the two vessels as per the required pressure of the vessels.

In case the pressure is stabilize in the vessel the air surge tank goes into idle mode.

This is a continuous process it works with the coordination of Injection pumping and displacement through the penstock Jet.

Process 2 (The vessel design of Process 2 is critical but the output can be more beneficial than Process 1 but applicable for smaller diameter vessel design)

If vessel is made with gravity plate, we will get better result but design of the vessel is critical and limited for small diameter vessels. Two High pressure vessels are required inside which there is a movable gravity plate with tightly sealed rubber to separate the water and air.

The pumped water enters into the vessel through a flexible pipe jet below the gravity plate (refer to Part B). The water pressure pushes the Gravity Plate upwards.

In part A, Air pressure is created by the air surge tank or by compressor. The pressure presses the gravity plate downwards and the plate presses the fluid. The fluid pressure will increase with the help of gravity plate by air pressure. The Gravity plate moves upwards or downwards based on the water or air pressure respectively. In an embodiment, the air surge tank uses a high pressure air compressor 113 to generate lower volume at high pressure air to fill air in the air surge tank at required bar and volume.

Both vessels are connected with each other in both compartments to maintain the same pressure in both the vessels. Valves are fitted at every point in both the vessels. A ‘Y’ shaped Penstock is used to connect both the vessels at the bottom and it merges to make a single penstock for next process.

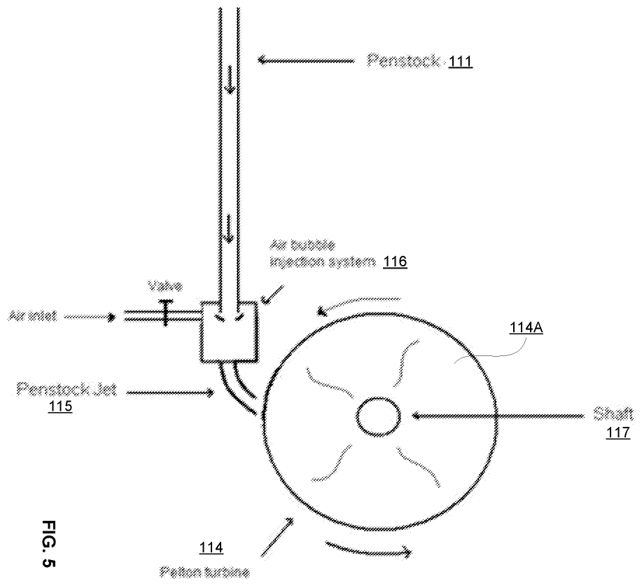

FIG. 5 illustrates a penstock jet realizing jet stream over a Pelton wheel 114 of the Pelton turbine 114 and both vessels are connected by a ‘Y’ shaped penstock. The point where the penstock meets the vessel is sealed by an outlet valve. Both vessels penstock merge into one penstock and connect with the jet placed over the Pelton Turbine.

In an embodiment, a pen stock jet 115 may be placed over the penstock, wherein the jet is injected with air bubbles through an air bubble injection system 116 and pushes the water from the penstock at high velocity over a Pelton wheel 114A of a Pelton turbine 114 which in turn moves turbine shaft 117, wherein the shaft is connected to a generator 118 to generate electricity.

In an embodiment, the pressurized water from at least one vessel or from series of vessels is released over the turbine by a penstock. The airdrop injection facilitates the penstock jet to boost impact torque over the turbine blade to produce more rpm.

In an embodiment, a gear assembly may be used between the turbine and the generator for increasing the rpm. The generator is connected to a step-up transformer for transferring the electricity to a grid.

FIG. 6 illustrates a schematic view of entering jet stream of water into the wheel and exiting jet stream of water from the wheel of the Pelton turbine according to an embodiment mentioned herein. Through the jet placed over the penstock the water is released over the Pelton wheel. Before the water moves out from the penstock jet some air bubbles are injected in the jet. These air bubbles help to give a further push to the already high velocity water-Displacement. Due the high pressure the High Head Potential Energy already present in the vessel converts itself into Kinetic Energy when it passes through the penstock jet. Due to the addition of the air bubbles in displacement flow, the kinetic energy of the water increases and it blasts over the blades of the turbine. Due to this impact, the torque of water increases to move the turbine most efficiently. The turbine shaft is connected to the generator to generate electrical energy. The discharged water is drained out through gravity to the reservoir for recycling. This cyclical process continuously generates electricity.

In this methodology the input and output energy are in different forms, as described in above drawings of drive machine and fulcrum. The Electrical energy given to the motor which rotates the main shaft through the gear box, with less input power i.e. 2 kW, will produce the rotational force through the main shaft which is attached on the fly arm and works like a piston to apply acting force on the effort arm to produce momentum at the resistance arm in a fulcrum method.

In this process, rotational force applied through the fly arm on above effort arm which is 10 times more than the input power given to the electric motor of the drive machine. If the input power is 2 kW at 1000 RPM, it will generate an output force compared to 20 kW at 20 RPM. This conversion of energy gives us a higher piston force to pull and push the effort arm.

As per Law of Archimedes, force applied over the effort arm gets multiplied with distance, which gives us higher output force from the resistance arm. As an example, if the effort arm is 10 meters long and resistance arm is 1 meter long and force or mass of 10 tons is applied on the effort arm then the resistance arm can lift an output force of more than 100 tons

This application is used to pump-up and down the piston plate of the injection pump to produce large acting force on the piston plate to pump up high pressure and volume water from injection pump to the vessel in very less input electrical energy given to the drive machine. We can get more output force from resistance arm with increase in effort arm length and decrease in resistance arm length from static support.

Injection pump works with the Principle of Pascal's Law i.e. Diameter of the injection pump is 400 mm and diameter of the vessel is 1000 mm. The force needed to pump up the same volume and pressured water from pump to vessel will be a less as compared to the output force from the vessel. It works on the methodology of The Hydraulic Jack.

(Input force X Area=Output Force X Area)

More surface area of the vessel gets more output force from the vessel i.e. If the input force of the injection pump is more than 100 tons for 400 mm pump diameter then output force from vessel will be more than 1000 tons. This pressure is developed over the surface of the stored water in the vessel.

This surface pressure developed in the water is stored in the form of potential energy but as liquid is non compressible but air can be compressed or expanded. we develop surface pressure above the stored water by compressed air in the vessel.

The stored water potential energy converts into kinetic energy to rotate the turbine. Turbine works on 2 basic inputs i.e. displacement flow over the turbine blade and present head of the displaced water. The input pumped water from the injection pump and displaced water over the turbine blade through the jet will be the same. i.e. If we get 3-meter cube per minute from each pump and if we fit 10 pumps in a line which work for 20 cycles each in a minute, we will get 30 meter cube water per minute or 0.5 meter cube per second to the vessel at 100 bar pressure.

The vessel pressure will be constant because the air is filled by the compressor at 100 bar and is maintained by air surge tank at same pressure. This will give us a 0.5-meter cube per second displacement flow continuously at 100 bar pressure. It is displaced over the turbine blade to generate the electrical energy from the generator.

Transformation Process—In our invention input energy given to the motor of the drive machine is relatively very small in the form of electrical power. It transforms into a rotational force of the drive machine and acts like a force or Mass to push and pull the effort arm.

Applied force multiplied by distance of the effort arm and static support, pump up the high-pressure water from pump to the vessel. Further when Applied force over the injection pump piston plate is multiplied with the diameter of the vessel, we get higher output force than the input of the injection pump piston plate.

This process transforms it into the form of Potential energy and stores it into the vessel.

The vessel is filled with high pressure air to produce desired surface pressure and stabilize it into the constant vessel pressure during operational penstock.

Air pressure once developed in the vessel maintains constant surface pressure on the water to maintain constant potential energy in the cyclically pumped stored water.

This Potential energy of stored water converts into the Kinetic energy to rotate the turbine and to give us electrical energy.

The input energy supplied to the drive machine and for compressing the air is not more than 5% of the total output energy generated during this energy transformation process.

In our Air-hydro Power Generation Technology, high pressure water is pumped up with the help of Drive Machine, Fulcrum and Injection type pump to inject water into the high pressure air-sealed vessel.

In this vessel, pressure is developed over the stored water in the vessel at required bar with the help of Air Surge Tank and Air Compressor fitted in line to compress and fill the air in vessel.

High pressure air creates pressure above the surface of stored water in the vessel.

The displaced water from the vessel through the penstock is continuously received into the vessel parallel at same volume and pressure through the injection pumping system. The water is continuously stored in the vessel from the injection pumping system which is released out.

Air Surge tank maintains the same pressure and stabilises the process in both the vessel during working. The two vessels are connected from below with a ‘Y’ shaped penstock which then merges into a single penstock. The high pressured water stored in the vessels is released into the penstock.

We can develop the pressure into the vessel from 5 Bar to 300 Bar, developed pressure creates Head for stored water. The stored water's Potential Energy converts into Kinetic Energy and injects on to the Pelton turbine through the jet, but before that air bubbles are added to the end of the penstock jet. The already high velocity and pressure of the water gets a boost through the penstock jet over the turbine, due to the air bubbles. The kinetic energy and torque of the injected water blasts on the blades to rotate the shaft of the turbine.

The turbine shaft is connected to the generator which is connected to the transformer and grid. The discharged water from the Pelton turbine naturally flows into the reservoir ready for the next cycle of generation.

The Mechanical Equation
Injection Pump—10 Nos having size 400 mm diameter each fitted in line and connected to the vessel
Piston Stroke—950 mm
Stroke Cycles—20 Nos
Drive Force—120 tons
To drive above specification injection pump we need to supply 2 kW input electrical energy to each drive machine with

Air Compressor 2.2 kW at 1.5 CFM (capacity upto 300 bar)

Above specified pumps pump upto 0.5 meter cube per second water into the vessel at 100 bar pressure.

Displacement of the Penstock Jet will be 0.5 meter cube per second.

Water pressure converted into head in meter. Converting pressure into bar to head (M).

h=P×10.197/SG

h=head (M)

SG=Specific Gravity

We consider Pressure for production in the vessel=100 bar.

h=P×10.197/SG

h=100×10.197/SG

h=1019.7 meter
Add accelerating downward motion head=10 meter

Total head=1019.7+10=1029.7 meter
For power generation from hydro power

P=npQgh
Where,
P=power in watts.
n=dimensionless efficiency of the turbine
p=density of water in kilograms per cubic meter
Q=flow in cubic meters per second
g=acceleration due to gravity
h=height difference between inlet and outlet in the meters as head The standard efficiency of the Pelton turbine is 85% with water Density 1000 kg/cubic meter.

The flow rate is 0.5 cubic meters/second. *(How much water we can pump up through inline fitted injection pumps per second will be consider for flow rate) Gravity of 9.81 meters per second square and with a net head of 1029.7 meters.

$$P = npQgh$$

$$Power ( W ) = 0.85 \times 1000 \times 0.5 \times 9.81 \times 1029.7$$

$$\begin{matrix}Power = 4169250 watt \\ = 4169.25 kW\end{matrix}$$

$$Power = 4.16 MW$$

$$Consumed Input Energy = 25 kW . ( It can vary with change in load design , \\ but not more than 5 \% of the output )$$

The efficiency of generating power with the technology of air hydropower will be more due to the addition of the air drop system in the penstock jet. This equation of output will change as per pumping flow or displacement flow rate, developed pressure into the vessel and size of the design.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

I claim:

1. An improved system for generating electrical energy from air hydropower, said system comprising;
a series arrangement of more than one vessel characterized in that wherein each of the vessel is cylindrical in shape at center, a dome shaped structure at top and a narrow conical structure at bottom, such that the vessels connected to an injection pumping system at the bottom side and to an air surge tank at top of the vessel such that the pressure in all the vessels are maintained in the range 5 Bar to 300 Bar;
a mechanical drive machine and a fulcrum assembly having an effort arm and a resistance arm resting on a static support, wherein the effort arm is connected to a drive mechanism and the resistance arm is connected to a piston rod, wherein the piston rod is connected to a piston plate with a rubber seal for pumping water from a reservoir;
an injection pumping system which includes an injection pump which is separated into two compartment by the piston plate, wherein each of the compartment has an input valves and an output valves that pumps water from the reservoir into the vessels;
a Y shaped penstock connected at the narrow conical structure at one end and formed from more than one narrow piping merging into a single pipe, wherein the penstock receives pressurized water from the vessel continuously at same volume and pressure as received from the injection pumping system to the vessel; and
a pen stock jet placed over the penstock, wherein the jet is injected with air bubbles through an air bubble injection system and pushes the water from the penstock at high velocity over a Pelton wheel of a Pelton turbine which in turn moves turbine shaft, wherein the shaft is connected to a generator to generate electricity.

2. The system as claimed in claim 1, wherein the drive machine when moves upwards and downwards with movement of effort arm and resistance arm, the resistance arm connected to the pump piston moves in upward direction towards point (a) the inlet valve of Compartment B opens and outlet valve of compartment B closes and at the same time compartment A outlet valve opens and inlet valve of compartment A closes, wherein when pump piston moves in downward direction towards point (b) the inlet valve of compartment A opens and outlet valve of compartment A closes, at the same time outlet valve of compartment B opens and inlet valve of compartment B closes.

3. The system as claimed in claim 1, wherein the air surge tank uses a high pressure air compressor to generate lower volume at high pressure air to fill air in the air surge tank at required bar and volume.

4. The system as claimed in claim 1, wherein the pressurized water from at least one vessel or from series of vessels is released over the turbine by a penstock.

5. The system as claimed in claim 1, wherein the airdrop injection facilitates the penstock jet to boost impact torque over the turbine blade to produce more rpm.

6. The system as claimed in claim 1, wherein a gear assembly is used between the turbine and the generator for increasing the rpm.

7. The system as claimed in claim 1, wherein the generator is connected to a step-up transformer for transferring the electricity to a grid.
